(19) United States
(12) Patent Application Publication
(10) Pub. No.: US 2015/0031342 A1
(43) Pub. Date: Jan. 29, 2015

(54) SYSTEM AND METHOD FOR ADAPTIVE SELECTION OF CONTEXT-BASED COMMUNICATION RESPONSES

(71) Applicant: Jose Elmer S. Lorenzo, Santa Clara, CA (US)

(72) Inventor: Jose Elmer S. Lorenzo, Santa Clara, CA (US)

(21) Appl. No.: 14/128,269

(22) PCT Filed: Jul. 24, 2013
(86) PCT No.: PCT/US2013/051787

§ 371 Date: Dec. 20, 2013

(51) Int. Cl. H04M 3/42; H04M 1/725; H04W 4/12; H04W 4/16

(52) U.S. Cl. CPC H04M 3/42365; H04W 4/16; H04M 1/72569; H04W 4/12
USPC 455/414.1; 455/556.1; 455/412.1

(57) ABSTRACT

A user communication device to receive and process data captured by one or more sensors during playback of an incoming communication on the user communication device and to identify user characteristics based on the captured data. The sensors may capture particular attributes of the user indicative of the user's reaction and/or mood in response to the incoming communication. The user characteristics include, but are not limited to, physical characteristics of the user, including facial expressions and physical movements in the form of gestures, as well as voice input, including tone of voice, from the user. The user communication device is further configured to identify media based on the user characteristics for inclusion in a communication to be transmitted in response to the incoming communication, the identified media including subject matter indicative of and corresponding to the mood of the user in response to the playback of the incoming communication.

### FIELD

The present disclosure relates to communication and interaction, and, more particularly, to a system and method for adaptive selection of context-based communication responses including media corresponding to a user's mood for use in communication between at least two communication devices.

### BACKGROUND

Modern communication devices are equipped with increased functionality, processing power and data storage capability to allow such devices to perform advanced processing. For example, many modern communication devices, such as typical “smart phones,” are capable of monitoring, capturing and analyzing large amounts data relating to their surrounding environment. Additionally, many modern communication devices are capable of connecting to various data networks, including the Internet, to retrieve and receive data communications over such networks.

Mobile and desktop communication devices are becoming ubiquitous tools for communication between two or more remotely located persons. While some such communication is accomplished using voice and/or video technologies, a large share of communication in business, personal and social networking contexts utilizes textual technologies. In some applications, textual communications may be supplemented with graphic content in the form of images, videos, animations, avatars and the like.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a device-to-device system for adaptive selection of context-based communication responses, including media corresponding to a user's mood, for use in communication transmitted by a user communication device consistent with various embodiments of the present disclosure;

FIG. 2 is a block diagram illustrating at least one embodiment of a user communication device of the system of FIG. 1 consistent with the present disclosure;

FIG. 3 is a block diagram illustrating a portion of the user communication device of FIG. 2 in greater detail;

FIG. 4 is a block diagram illustrating another portion of the user communication device of FIGS. 2 and 3 in greater detail;

FIG. 5 is a block diagram illustrating another portion of the user communication device of FIGS. 2 and 3 in greater detail; and

FIG. 6 is a flow diagram illustrating one embodiment of a method for adaptive selection of context-based communication responses, including media corresponding to a user's mood, for use in communication transmitted by a communication device consistent with the present disclosure.

For a thorough understanding of the present disclosure, reference should be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient.

### DETAILED DESCRIPTION

By way of overview, the present disclosure is generally directed to a system and method for adaptive selection of context-based communication responses for use in communication between a user communication device and at least one remote communication device. The user communication device is configured to receive and process data captured by one or more sensors during playback of an incoming communication on the user communication device and further identify user characteristics based on the captured data. In particular, during playback of an incoming communication on the user communication device, the one or more sensors may capture particular attributes of the user indicative of the user's reaction and/or mood in response to the incoming communication. The user characteristics may include, but are not limited to, physical characteristics of the user, including facial expressions and physical movements in the form of gestures, as well as voice input, including tone of voice, from the user.

The user communication device is further configured to determine an overall mood assessment of the user based on the user characteristics and further identify media based on the mood assessment. The identified media may include subject matter indicative of and corresponding to the overall mood assessment of the user in response to the playback of the incoming communication. The identified media may be from one or more soures, such as, for example, a cloud-based service and/or a local media database on the communication device. The user communication device is further configured to generate a communication including the identified media to be transmitted by the user communication device in response to the incoming communication.

A system consistent with the present disclosure provides an intuitive means of identifying relevant media for inclusion in an active communication between communication devices based, at least in part, on characteristics of at least one user of a communication device, including recognized facial expressions, body movement and/or subject matter of voice input, including tone of voice, from the user. The system may be configured to continually monitor user characteristics during exchange of communications between the communication devices, specifically during playback of incoming messages sent from a remote communication device to a user communication device. The system may be further configured to adaptively identify and provide associated media for inclusion in communication responses from the user communication device to the remote communication device in real-time or near real-time. Accordingly, the system may promote enhanced interaction and foster further communication between communication devices and the associated users.

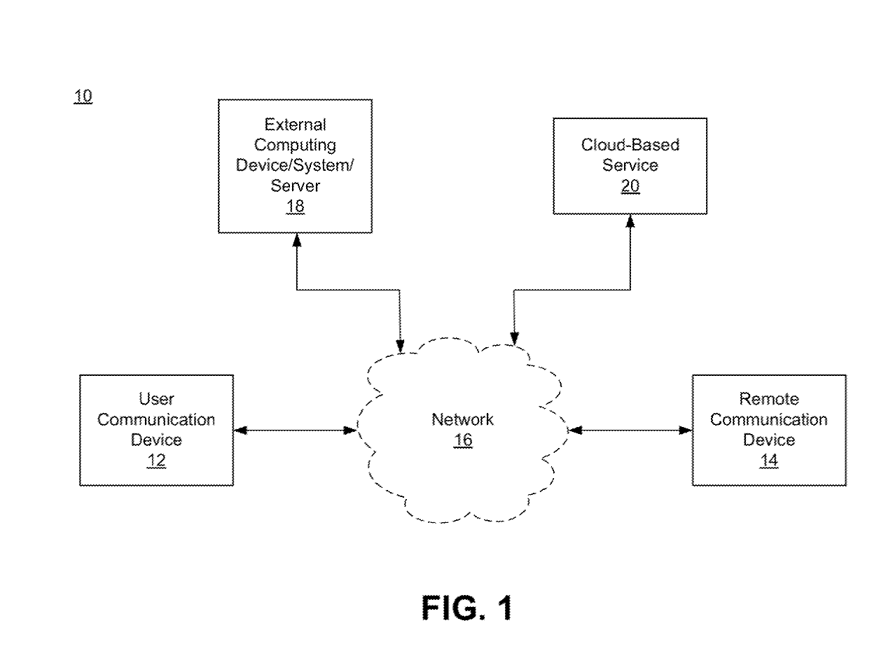

Turning to FIG. 1, one embodiment of a system for adaptive selection of a communication response including media corresponding to a user's mood for use in communication between at least two communication devices is generally illustrated. As shown, the system 10 includes a user communication device 12 configured to be communicatively coupled to at least one remote communication device 14 via a network 16. The user communication device 12 may also be communicatively coupled to an external device, system or server 18 and/or cloud-based service 20 via the network 16, in addition, or alternatively, to the remote communication device 14.

The user communication device 12 may be embodied as any type of device for communicating with one or more remote devices/systems/servers and for performing the other functions described herein. For example, the user communication device 12 may be embodied as, without limitation, a computer, a desktop computer, a personal computer (PC), a tablet computer, a laptop computer, a notebook computer, a mobile computing device, a camera, a smart phone, a cellular telephone, a handset, a messaging device, a work station, a network appliance, a web appliance, a distributed computing system, a multiprocessor system, a processor-based system, a consumer electronic device, a digital television device, a set top box, and/or any other computing device configured to store and access data, and/or to execute electronic game software and related applications. A user may use multiple different user communication devices 12 to communicate with others, and the user communication device 12 illustrated in FIG. 1 will be understood to represent one or such communication devices.

The remote communication device 14 may likewise be embodied as any type of device for communicating with one or more remote devices/systems/servers. Example embodiments of the remote communication device 14 may be identical to those just described with respect to the user communication device 12.

The external computing device/system/server 18 may be embodied as any type of device, system or server for communicating with the user communication device 12, the remote communication device 14 and/or the cloud-based service 20, and for performing the other functions described herein. Examples embodiments of the external computing device/system/server 18 may be identical to those just described with respect to the user communication device 12 and/or may be embodied as a conventional server, e.g., web server or the like.

The network 16 may represent, for example, a private or non-private local area network (IAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the user communication device 12 and the remote communication device 14 between the user communication device 12 and the external computing device/system/server 18 and/or cloud-based service 20, may be, in whole or in part, a wired connection.

The network 16 may be any network that carries data. Non-limiting examples of suitable networks that may be used as network 16 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), other networks capable of carrying data, and combinations thereof. In some embodiments, network 16 is chosen from the internet, at least one wireless network, at least one cellular telephone network, and combinations thereof. As such, the network 16 may include any number of additional devices, such as additional computers, routers, and switches, to facilitate communications. In some embodiments, the network 16 may be or include a single network, and in other embodiments the network 16 may be or include a collection of networks.

As described in greater detail herein, the user communication device 12 is configured to receive one or more incoming communications from at least one of the remote communication device 14, external device, system or server 18 and/or the cloud-based service 20. The incoming communication may include, but is not limited to, a video message, virtual avatar message, voicemail message, text message and notification (e.g. post on social medial platform, push notification from active running application, etc.). Further, the user communication device 12 is configured to transmit one or more reply communications in response to received incoming communications.

The user communication device 12 is configured to acquire data related to a user of the device at least during playback of a communication received from at least one of the remote communication device 14, external device, system or server 18 and/or cloud-based service 20. The user data may be acquired from one or more devices and/or sensors on-board the user communication device 12 and/or from one or more sensors external to the user communication device 12. The user communication device 12 is further configured to determine characteristics of the user based on the captured user data. The user characteristics may include, but are not limited to, physical characteristics of the user, including facial expressions and physical movements in the form of gestures, as well as voice input from the user generally indicative of the user's reaction and/or mood in response to the received communication.

The user communication device 12 is further configured to determine an overall mood assessment of the user based on the user characteristics and further identify media based on the mood assessment for inclusion in a communication to be transmitted by the user communication device 12 in response to the received communication. The identified media may include content or subject matter indicative of and corresponding to the overall mood assessment (e.g., happy, sad, surprised, angry, level of interest, etc.) of the user in response to the playback of the incoming communication. The identified media may be from one or more sources, such as, for example, the external device, system or server 18, cloud-based network or service 20 and/or a local media database on the device 12.

The user communication device 12 is further configured to generate one or more communications including the identified media to be transmitted by the user communication device 12 to another device or system in response to the incoming communication. For example, the user communication device 12 may be configured to transmit a communication response to at least one of the remote communication device 14 and one or more subscribers, viewers and/or participants of one or more social network, blogging, gaming or other services hosted by the external computing device/system/server 18 and/or cloud-based service 20.

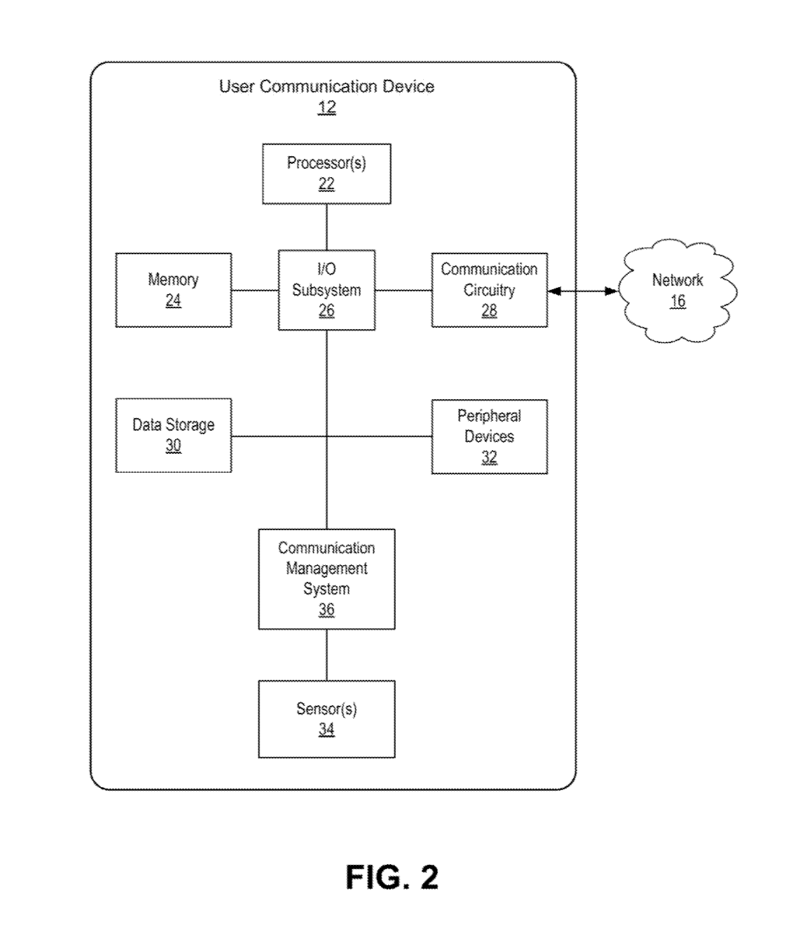

Turning to FIG. 2, at least one embodiment of a user communication device 12 of the system 10 of FIG. 1 is generally illustrated. In the illustrated embodiment, the user communication device 12 includes a processor 22, a memory 24, an input/output subsystem 26, communication circuitry 28, a data storage 30, peripheral devices 32, one or more sensors 34 and a communication management system 36. As generally understood, the user communication device 12 may include fewer, other, or additional components, such as those commonly found in conventional computer systems. Additionally, in some embodiments, one or more of the illustrative components may be incorporated in, or otherwise from a portion of, another component. For example, the memory 24, or portions thereof, may be incorporated into the processor 24 in some embodiments.

The processor 22 may be embodied as any type of processor capable of performing the functions described herein. For example, the processor may be embodied as a single or multi-core processor(s), digital signal processor, microcontroller, or other processor or processing/controlling circuit. Similarly, the memory 24 may be embodied as any type of volatile or non-volatile memory or data storage capable of performing the functions described herein. In operation, the memory 24 may store various data and software used during operation of the user communication device 12 such as operating systems, applications, programs, libraries, and drivers. The memory 24 is communicatively coupled to the processor 22 via the I/O subsystem 26, which may be embodied as circuitry and/or components to facilitate input/output operations with the processor 22, the memory 24, and other components of the user communication device 12.

For example, the I/O subsystem 26 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 26 may form a portion of a system-on-a-chip (SoC) and be incorporated, along with the processor 22, the memory 24, and other components of user communication device 12, on a single integrated circuit chip.

The communication circuitry 28 of the user communication device 12 may be embodied as any communication circuit, device, or collection thereof, capable of enabling communications between the user communication device 12 and any one of the remote communication device 14, external device, system, server 18 and/or cloud-based service 20 via the network 16. The communication circuitry 28 may be configured to use any one or more communication technology and associated protocols, as described above, to effect such communication.

The data storage 30 may be embodied as any type of device or devices configured for short-term or long-term storage of data such as, for example, memory devices and circuits, memory cards, hard disk drives, solid-state drives, or other data storage devices. In the illustrative embodiment, the user communication device 12 may maintain one or more application programs, databases, media and/or other information in the data storage 30. As described in greater detail below, media may be stored in the data storage 30 and utilized by the communication management system 36 for inclusion in a communication response to be transmitted by the device 12 to the remote communication device 14 and/or to the external device/system/server 18 and/or cloud-based service 20 in the form of images, animations, audio files and/or video files.

The peripheral devices 32 may include one or more devices for interacting with the device 12, such as a display, a keypad and/or one or more audio speakers. In one embodiment, the device 12 may include a touch-sensitive display (also known as “touch screens” or “touchscreens”), in addition to, or as an alternative to, physical push-button keyboard or the like. The touch screen may generally display graphics and text, as well as provides a user interface (e.g., but not limited to graphical user interface (GUI)) through which a user may interact with the user device 12, such as accessing and interacting with applications stored in the data storage 30. As generally understood, playback of an incoming communication sent from the remote communication device 14, for example, may be presented to a user by way of the display and/or audio speakers on the user communication device 12.

The user communication device 12 further includes one or more sensors 34. Generally, the sensors 34 are configured to capture data related to the user of the user communication device 12, specifically during playback of an incoming communication. As described in greater detail herein, the sensors 34 may be configured to capture data relating to physical characteristics of the user, such as facial expressions and body movements, as well as voice input, including tone of voice, from the user. Accordingly, the sensors 34 may include, for example, a camera and a microphone.

The user communication device 12 further includes a communication management system 36. As described in greater detail herein, the communication management module 36 is configured to receive data captured by the one or more sensors 34 and further determine characteristics of the user based on an analysis of the captured data. The communication management module 36 is further configured to determine an overall mood assessment of the user based on the user characteristics and further identify media based on the mood assessment and having content or subject matter indicative of and corresponding to the overall mood assessment (e.g., happy, sad, surprised, angry, level of interest, etc.). The identified media may be from one or more sources, such as, for example, the external device, system or server 18, cloud-based network or service 20 and/or a local media database on the device 12. The communication management module 36 is configured to generate a communication including the identified media in response to the incoming communication.

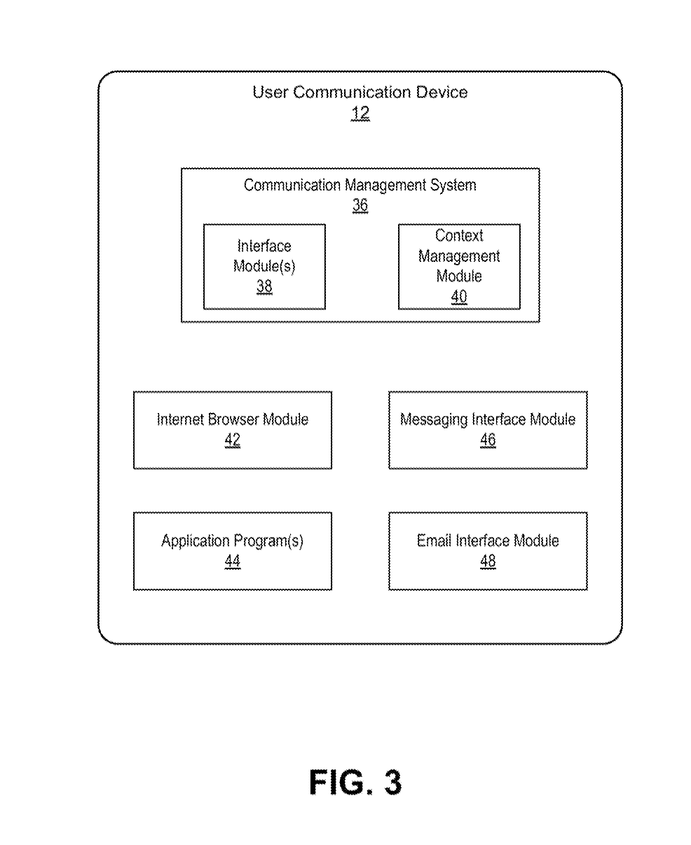

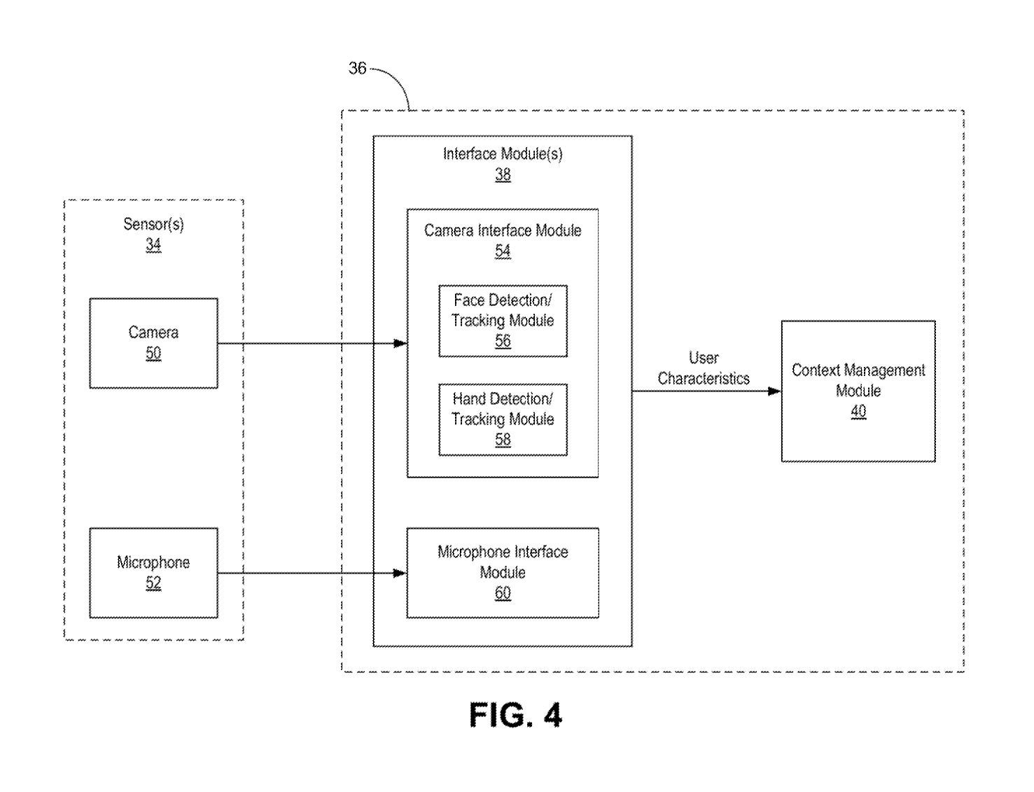

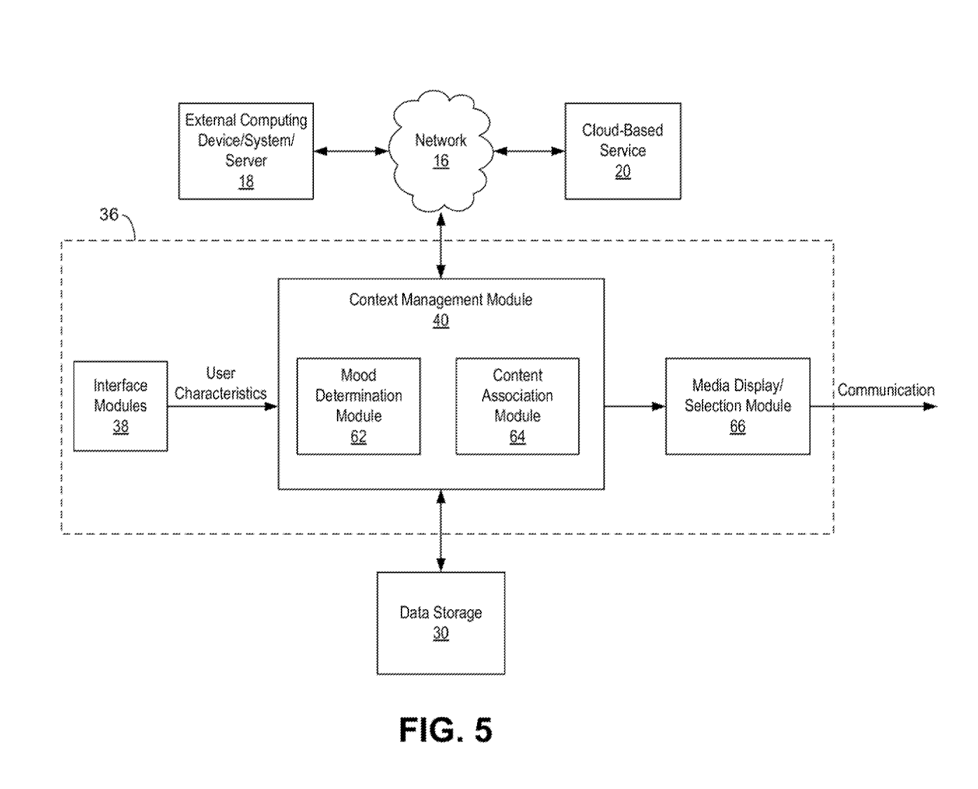

Turning to FIG. 3, at least one embodiment of the user communication device 12 of FIGS. 1 and 2 is generally illustrated. In the illustrated embodiment, the user communication device 12 includes the communication management system 36, wherein the communication management system 36 includes interface modules 38 and a context management module 40. The user communication device 12 further includes an internet browser module 42, one or more application programs 44, a messaging interface module 46 and an email interface module 48. As described in greater detail herein, particularly with reference to FIGS. 4 and 5, the interface modules 38 are configured to process and analyze data captured from corresponding sensors 34 to determine one or more user characteristics based on analysis of the captured data. The context management module 40 is further configured to receive the user characteristics and identify media associated with the user characteristics to be included in a communication to be transmitted from the device 12 to the remote communication device 14, for example.

The internet browser module 42 is configured, in a conventional manner, to provide an interface for the perusal, presentation and retrieval of information by the user of the user communication device 12 of one or more information resources via the network 16, e.g., one or more websites hosted by the external computing device/system/server 18 and/or cloud-based service 20. The application program(s) 44 may include any number of different software application programs, each configured to execute a specific task, and from which user information data, i.e., information about the user of the user communication device 12, may be determined or obtained. Any such application program may use information obtained from at least one of the sensors 34, from one or more other application programs, from one or more of the user communication device modules, and/or from the external computing device/system/server 18 or cloud-based service 20 to determine or obtain the user information data.

The messaging interface module 46 is configured, in a conventional manner, to provide an interface for the exchange of messages between two or more remote users using a messaging service. e.g., a mobile messaging service (mms) implementing a so-called “instant messaging” or “texting” service, and/or a microblogging service which enables users to send text-based messages of a limited number of characters to wide audiences, e.g., so-called “tweeting.” The email interface module 48 is configured, in a conventional manner, to provide an interface for composing, sending, receiving and reading electronic mail.

As will be described in greater detail below, the interface modules 38 of the communication management system 36 are configured to automatically acquire user information data from associated sensors 34 relating to occurrences of stimulus events that are above a threshold level of change for any such stimulus event. In turn, the interface modules 38 are configured to determine characteristics of the user based on analysis of the user information data. The context management module 40 is configured to automatically search for and identify media associated with the user characteristics for inclusion into a communication to be transmitted to at least one of the remote communication device 14, the external computing device/system/server 18 and the cloud-based service 20, via the internet browser module 42, the messaging interface module 46 and/or the email interface module 48.

The communications being undertaken by the user of the user communication device 12 may be in the form of mobile or instant messaging, e-mail, blogging, microblogging, communicating via a social media service, communicating during or otherwise participating in on-line gaming, or the like. In one embodiment, the user communication device 12 may be configured to allow the user to select identified media corresponding to the user characteristics and to further select and/or customize a communication response, including the identified media, to be transmitted by the user communication device 12.

FIGS. 4 and 5 generally illustrate portions of the user communication device 12 of FIGS. 2 and 3 in greater detail. Referring to FIG. 4, the sensors 34 include at least a camera 50 configured to capture one or more images of the user and a microphone 52 configured to capture sound data, including vocal information produced by the user, during playback of the incoming communication on the device 12.

It should be noted that FIG. 4 illustrates one embodiment of set of sensors included in a user consumer device 12 consistent with the present disclosure and, by no means, is meant to limit the type of sensors for use in a system and/or method consistent with the present disclosure. For example, the device 12 may include additional sensors on-board the user communication device 12, including, but not limited to, an accelerometer or other motion or movement sensor to produce sensory signals corresponding to motion or movement of the user of the user communication device 12, a magnetometer to produce sensory signals from which direction of travel or orientation can be determined, an ambient light sensor to produce sensory signals corresponding to ambient light surrounding or in the vicinity of the device 12 and a proximity sensor to produce sensory signals corresponding to the proximity of the device 12 to one or more objects.

In any case, the sensors 34 are configured to capture user information data during playback of an incoming communication on the device 12. User information may include, but is not limited to, a user's physical attributes, including facial features (e.g. eyes, mouth, cheeks, teeth, etc.) and/or other parts of a user's body (e.g. hands and/or fingers), as well as vocal information spoken, sung or otherwise produced by the user.

As previously described, the communication management system 36 includes interface modules 38 configured to user data captured by the sensors 34 and establish user characteristics of the user based on analysis of the captured data. In the illustrated embodiment, the communication management system 36 includes a camera interface module 54 and a microphone interface module 66.

The camera interface module 54 is configured to receive one or more digital images captured by the camera 50. The camera 50 may be embodied as any type of digital camera capable of producing still or motion pictures from which the user communication device 12 may determine user information data. The camera 50 includes any device (known or later discovered) for capturing digital images representative of an environment that includes one or more persons, and may have adequate resolution for face analysis of the one or more persons in the environment as described herein.

For example, the camera 50 may include a still camera (i.e., a camera configured to capture still photographs) or a video camera (i.e., a camera configured to capture a plurality of moving images in a plurality of frames). The camera 50 may be configured to capture images in the visible spectrum or with other portions of the electromagnetic spectrum (e.g., but not limited to, the infrared spectrum, ultraviolet spectrum, etc.). The camera 50 may be further configured to capture digital images with depth information, such as, for example, depth values determined by any technique (known or later discovered) for determining depth values. For example, the camera 50 may include a depth camera that may be configured to capture the depth image of a scene within the computing environment. The camera 50 may also include a three-dimensional (3D) camera and/or a RGB camera configured to capture the depth image of a scene.

The camera 50 may be incorporated within the user communication device 12 or may be a separate device configured to communicate with the user communication device 12 via wired or wireless communication. Specific examples of cameras 50 may include wired (e.g., Universal Serial Bus (USB), Ethernet, Firewire, etc.) or wireless (e.g., WiFi, Bluetooth, etc.) web cameras as may be associated with computers, video monitors, etc., mobile device cameras (e.g., cell phone or smart phone cameras integrated in, for example, the previously discussed example computing devices), integrated laptop computer cameras, integrated tablet computer cameras, etc.

Upon receiving the image(s) from the camera 50, the camera interface module 54 may be configured to identify physical characteristics of the user. In particular, the camera interface module 54 may be configured to identify features of a user, including the face and/or other portions of the user's body, as well as facial expressions and gestures. For example, the camera interface module 54 may include a face detection and tracking module 56 configured to identify a face and/or face region within the image(s) and determine one or more facial characteristics of the user. As generally understood by one of ordinary skill in the art, the face detection/tracking module 56 use any known internal biometric modeling and/or analyzing methodology to identify face and/or face region with the image(s). For example, the face detection/tracking module 56 may include custom, proprietary, known and/or after-developed face recognition and facial characteristics code (or instruction sets), hardware, and/or firmware that are generally well-defined and operable to receive a standard format image and identify, at least to a certain extent, a face in the image(s) and facial features (e.g. eyes, mouth, cheeks, teeth, tongue, etc.).

The face detection/tracking module 56 may further include custom, proprietary, known and/or after-developed facial expression detection and/or identification code (or instruction sets) that is generally well-defined and operable to detect and/or identify facial expressions of the user in the image(s). For example, the face detection/tracking module 56 may determine size and/or position of the facial features (e.g., eyes, mouth, cheeks, teeth, tongue, etc.) and compare the facial features to a facial feature database which includes a plurality of sample facial features with corresponding facial feature classifications (e.g., laughing, crying, smiling, frowning, excited, sad, etc.). The facial expressions of a user may generally be indicative of the user's mood and reaction to the incoming communication presented on the device 12.

The camera interface module 54 may further include a hand detection and tracking module 58 configured to identify one or more parts of the user's body within the image(s) provided by the camera 50 and track movement of such identified body parts to determine one or more gestures performed by the user. For example, the hand detection and tracking module 58 may include custom, proprietary, known and/or after-developed identification and detection code (or instruction sets), hardware, and/or firmware that are generally well-defined and operable to receive an image (e.g., but not limited to, a RGB color image) and identify, at least to a certain extent, a user's hand in the image and track the detected hand through a series of images to determine an air-gesture based on hand movement. The camera interface module 54 may further be configured to identify and track movement of a variety of body parts and regions, including, but not limited to, head, torso, arms, hands, legs, feet and the overall position of a user within a scene.

The microphone interface module 60 is configured to receive voice data of the user (as well as other vocal utterances of the user, such as laughter or crying) captured by the microphone 52. The microphone 52 may be embodied as any type of audio recording device capable of capturing local sounds and producing audio signals detectable and usable by the user communication device 12 to determine user information data. For example, the microphone 52 includes any device (known or later discovered) for capturing voice data of at least one person, and may have adequate digital resolution for voice analysis of the at least one person.

Upon receiving the voice data from the microphone 52, the microphone interface module 60 may be configured to use any known speech analyzing methodology to identify particular subject matter of the voice data. For example, the microphone interface module 60 may include custom, proprietary, known and/or after-developed speech recognition and characteristics code (or instruction sets), hardware, and/or firmware that are generally well-defined and operable to receive voice data and translate speech into text data. For example, the microphone interface module 60 may be configured receive voice data related to a sentence spoken by the user and identify one or more keywords indicative of subject matter of the sentence. Additionally, the microphone interface module 60 include custom, proprietary, known and/or after-developed sound recognition code (or instruction sets), hardware, and/or firmware that are generally well-defined and operable to receive sound data in the form of vocal utterances from the user and identify the type of vocal utterance (e.g. laugh, cry, yell, scream, etc.). Additionally, the microphone interface module 60 may be configured to identify one or more spoken commands from the user, as generally understood by one skilled in the art.

The context management module 440 is configured to receive data from the interface modules 38. More specifically, the camera and microphone interface modules 54, 60 are configured to provide the user characteristics to the context management module 40. For example, the camera interface module 54 may provide data related to detected facial expressions and/or gestures of the user and the microphone interface module 60 may provide data related to subject matter related to a user's spoken words.

Referring to FIG. 5, the context management module 40 includes a mood determination module 62 and a content association module 64. Generally, mood determination module 62 is configured to analyze the user characteristics from the interface modules 38 and determine an overall mood assessment of the user based on the analysis. In particular, the mood determination module 62 may be configured to analyze the user's facial characteristics and expressions (e.g. smile, frown, crying, surprised, excited, confused, angry, oblivious, etc.), movement of one or more portions of the user's their body, including hand movement (e.g. thumbs up, thumbs down) or movement of the user's head (e.g. nodding of their head, etc.), as well as vocal input from the user, including detected subject matter related to a user's spoken words and vocal utterances (e.g. laugh, scream, yell, etc.). The mood determination module 62 may be configured to determine the user's overall mood in response to viewing and/or hearing playback of the incoming communication. For example, the mood determination module 62 may include custom, proprietary, known and/or after-developed user reaction recognition and characteristics code (or instruction sets), hardware, and/or firmware that are generally well-defined and operable to receive one or more user characteristics and identify a general mood associated with each user characteristic.

For example, in one scenario, the user communication device 12 may receive a video message from the remote communication device 14. Upon playing the video message, the sensors 34 are configured to capture user information data, specifically the user's physical attributes, including facial features (e.g. eyes, mouth, cheeks, teeth, etc.) and/or other parts of a user's body (e.g. hands and/or fingers), as well as vocal information spoken, sung or otherwise produced by the user. The associated interface modules 38 are configured to analyze the user information data and identify user characteristics based on the analysis, including facial expressions, hand gestures and/or vocal input. For example, the video message may include subject matter that causes the user to smile and laugh. Accordingly, the user characteristics identified by the interface modules 38 would include a user's smile and laughter. In turn, the mood determination module 62 is configured to analyze the user characteristics and determine an overall mood assessment of the user, wherein, in the current example, the overall mood assessment would indicate that the user is in a relatively happy mood with respect to the video message. As generally understood, in other examples, depending on the subject matter of an incoming communication and the user's reaction to the incoming communication, the mood determination module 62 may be configured to determine one or more of a variety of different mood assessments, including, but not limited to, happy, sad, confused, angry, oblivious, uninterested, etc.

The content association module 64 is configured to identify media based on the mood assessment of the mood determination module 62. In particular, the content association module 64 may be configured to communicate with the data storage 26, the external device/system/server 18 and/or the cloud-based service 20 and search for and identify media having content and subject matter related to the mood assessment. As generally understood, the content association module 64 may include custom, proprietary, known and/or after-developed search and recognition code (or instruction sets), hardware, and/or firmware that are generally well-defined and operable to generate a search query related to the subject matter and search the data storage 26, the external device/system/server 18 and/or the cloud-based service 20 and identify media content corresponding to the search query and subject matter. For example, the content association module 64 may include a search engine. As may be appreciated, the content association module 64 may include other known searching components.

For example, in the event that the mood assessment indicates that the user is in a relatively happy mood, the content association module 64 may be configured to identify one or more media elements having content related to a generally happy mood or status, such as, for example, a still image of a person smiling or an emoticon smiley face. As generally understood, the content association module 64 may be configured to search for a variety of media elements, including, but not limited to, a still image, video clip, animation, audio clip, emoticon (static and motion) and text.

Upon identification of media associated with one or more of the contextual characteristics, the context management module 40 is configured to receive (e.g. download, stream, etc.) the identified media element and further include the identified media element(s) in a communication to be transmitted by the user communication device 12 in response to the incoming communication. In one embodiment, the communication management system 36 may be configured to automatically generate a reply communication including the identified media element(s) and transmit the automated reply communication to the original external device, server or system (e.g. remote communication device 14) that sent the incoming communication. The automated replay communication may be transmitted via at least one of the same mode of communication as the incoming communication, a predefined mode of communication (i.e. a social network platform) or a separate signaling communication channel containing only information related to the mood assessment data (e.g. Internet Protocol or transmission network channel separate from the reply communication). The reply communication may be in the form of at least one of a video message, virtual avatar message, voicemail message, text message and notification (e.g. post on social medial platform, push notification) that may include one or more still images, animated graphics and/or audio clips.

In other embodiments, the communication management system 36 may allow user selection of the identified media into a preconfigured or personalized reply communication. For example, in the illustrated embodiment, the communication management system 36 further includes a media display/selection module 66 configured to display and allow user selection of the identified media element on the display of the user communication device 12. The media display/selection module 66 is configured allow a user to selectively include an identified media element(s) in a reply communication to be transmitted by the user communication device 12.

In some embodiments, the communication management system 36 may include one or more components configured to provide archiving functions. In particular, the context management module 40 may be configured to transmit user characteristics and corresponding mood assessment to at least the data storage 30 for storage in corresponding profiles for the user. Each profile may include information related to the incoming communication, including sender metadata (e.g. data, time, location, network of communication) and the resulting user characteristics and corresponding mood assessment in response to the incoming communication. Accordingly, the communication management system 36 may be configured to continually refine the content association determination algorithm to identify incoming messages having content that may result in a particular type of mood response from the user, which may be particularly useful in predicting behavioral patterns of a user depending on specific types of incoming communications.

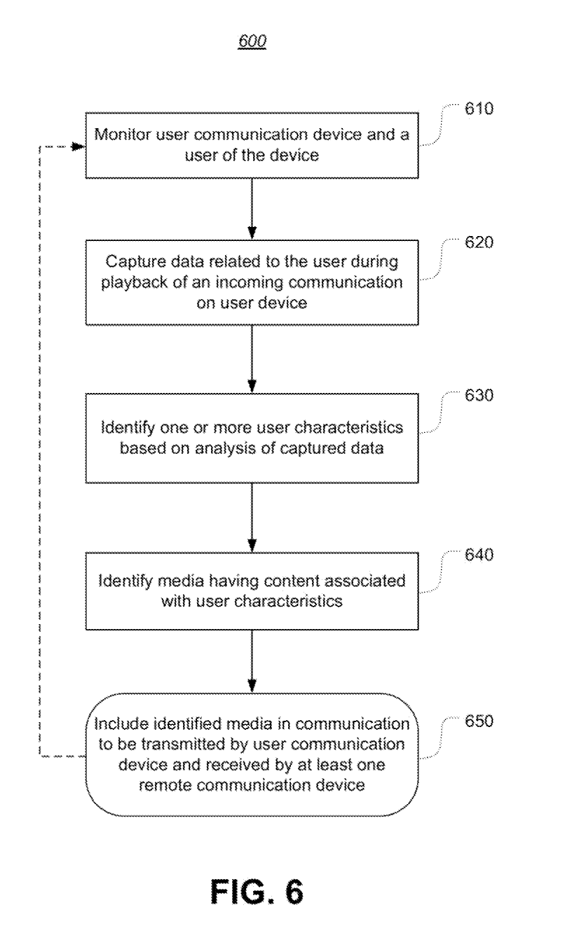

Turning now to FIG. 6, a flowchart of one embodiment of a method 600 for adaptive selection of context-based communication responses, including media corresponding to a user's mood, for use in communication transmitted by a communication device is generally illustrated. The method 600 includes monitoring a user communication device and a user of the device (operation 610) and capturing data related to the user during playback of an incoming communication on the user communication device (operation 620). Data may be captured by one of a plurality of sensors. The data may be captured by a variety of sensors configured to detect various characteristics of the user. The sensors may include, for example, at least one camera and at least one microphone.

The incoming communication may be sent to the user communication device from at least one of a remote communication device, cloud-based service or external computing device, system, server. The incoming communication may include, but is not limited to, a video message, virtual avatar message, voicemail message, text message and notification (e.g. post on social medial platform, push notification from active running application, etc.).

The method 600 further includes identifying one or more characteristics of at least a user of the user communication device based on analysis of the captured data (operation 630). In particular, interface modules may receive data captured by associated sensors, wherein each of the interface modules may analyze the captured data to determine one or more of the following user characteristics: physical characteristics of the user, including facial expressions and physical movements in the form of gestures, as well as voice input from the user, including subject matter of the voice input.

The method 600 further includes identifying media associated with the user characteristics (operation 640). In particular, an overall mood assessment of the user may be determined based on the user characteristics captured during playback of the incoming communication and the identified media may include subject matter indicative of and corresponding to the overall mood assessment of the user during playback of the incoming communication. The method 600 further includes including the identified media in a communication to be transmitted by the user communication device and received by at least one remote communication device (operation 650).

While FIG. 6 illustrates method operations according various embodiments, it is to be understood that in any embodiment not all of these operations are necessary. Indeed, it is fully contemplated herein that in other embodiments of the present disclosure, the operations depicted in FIG. 6 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The following examples pertain to further embodiments. The following examples of the present disclosure may comprise subject material such as a device, a method, at least one machine-readable medium for storing instructions that when executed cause a machine to perform acts based on the method, means for adaptive selection of communication responses including media corresponding to a user's mood for use in communication between at least two communication devices, as provided below.

Example 1 is a system for adaptively selecting media for inclusion in a communication to be transmitted from a user communication device. The system may include at least one sensor to capture data related to a user of a user communication device during presentation of an incoming communication on the user communication device, at least one interface module to identify user characteristics based on the captured data, the user characteristics indicative of the user's reaction in response to the incoming communication and a context management module to determine an overall mood assessment of the user based on the user characteristics and to identify media associated with the mood assessment, the identified media to be included in a reply communication to be transmitted by the user communication device in response to the incoming communication.

Example 2 includes the elements of example 1, wherein the at least one sensor is at least one of a camera and a microphone, the camera to capture one or more images of the user and the microphone to capture voice data from the user.

Example 3 includes the elements of example 2, wherein the at least one interface module is a camera interface module to analyze the one or more images and identify physical user characteristics based on the analysis, wherein the physical user characteristics are at least one of one or more facial expressions and movement of one of more parts of the user's body resulting in one or more gestures.

Example 4 includes the elements of example 3, wherein the one or more facial expressions is at least one of a smile, frown, crying, surprised, excited, confused, angry and oblivious.

Example 5 includes the elements of example 2, wherein the at least one interface module is a microphone interface module to analyze voice data from the microphone and identify subject matter of the voice data based on the analysis.

Example 6 includes the elements of example 5, wherein the voice data includes at least one of spoken words and vocal utterances from the user.

Example 7 includes the elements of any one of examples 1 to 6, wherein the context management module includes a mood determination module to analyze the user characteristics and determine an overall mood assessment of the user based on the analysis, wherein the mood assessment is at least one of happy, sad, excited, confused, angry, oblivious and uninterested.

Example 8 includes the elements of any one of examples 1 to 7, wherein the context management module includes a content association module to search for and retrieve media having content or subject matter related to the mood assessment, the media is provided by one or more media sources.

Example 9 includes the elements of example 8, wherein the one or more media sources includes at least one of a local data storage included on the user communication device, an external device/system/server and a cloud-based service.

Example 10 includes the elements of any one of examples 1 to 9, wherein the media includes at least one of an image, animation, audio file, video file, emoticon (static and motion), text and a network link to an image, animation, audio file or video file.

Example 11 includes the elements of any one of examples 1 to 10, further including a media display/selection module communicatively coupled to a display to allow selection of the identified media to be transmitted by the user communication device.

Example 12 includes the elements of any one of examples 1 to 11, wherein the reply communication includes at least one of a video message, virtual avatar message, voicemail message, text message and notification.

Example 13 is a method for adaptively selecting media for inclusion in a communication to be transmitted from a user communication device. The method may include capturing data related to a user of a user communication device during presentation of an incoming communication on the user communication device, identifying user characteristics based on the data, the user characteristics indicative of the user's reaction in response to the incoming communication and identifying media associated with at least one of the user characteristics, the identified media to be included in a reply communication to be transmitted by the user communication device in response to the incoming communication.

Example 14 includes the elements of example 13, wherein the at least one sensor is at least one of a camera and a microphone, the camera to capture one or more images of the user and the microphone to capture voice data from the user.

Example 15 includes the elements of example 14, further including analyzing the one or more images and identifying physical user characteristics based on the analysis, the physical user characteristics are at least one of one or more facial expressions and movement of one of more parts of the user's body resulting in one or more gestures.

Example 16 includes the elements of example 15, wherein the one or more facial expressions is at least one of a smile, frown, crying, surprised, excited, confused, angry and oblivious.

Example 17 includes the elements of example 14, further including analyzing the voice data and identifying subject matter of the voice data based on the analysis.

Example 18 includes the elements of any one of examples 13 to 17, wherein the identifying media associated with at least one of the user characteristics includes determining an overall mood assessment of the user based on the user characteristics, the mood assessment is at least one of happy, sad, excited, confused, angry, oblivious and uninterested and searching for and retrieving media having content or subject matter related to the mood assessment, the media is provided by one or more media sources.

Example 19 includes the elements of any one of examples 13 to 18, further including allowing selection of the identified media and including selected identified media in the reply communication.

Example 20 includes the elements of any one of examples 13 to 19, wherein the media includes at least one of an image, animation, audio file, video file, emoticon (static and motion), text and a network link to an image, animation, audio file or video file.

Example 21 includes the elements of any one of examples 13 to 20, wherein the reply communication includes at least one of a video message, virtual avatar message, voicemail message, text message and notification.

Example 22 comprises a system including at least a device, the system is arranged to perform the method set forth above in of any one of examples 13 to 21.

Example 23 comprises a chipset arranged to perform the method set forth above in of any one of examples 13 to 21.

Example 24 comprises at least one computer accessible medium having instructions stored thereon which, when executed by a computing device, cause the computing device to carry out the method set forth above in of any one of examples 13 to 21.

Example 25 comprises a device configured for adaptively selecting media for inclusion in a communication to be transmitted, the device is arranged to perform the method set forth above in of any one of examples 13 to 21.

Example 26 comprises a system having means to perform the method set forth above in of any one of examples 13 to 21.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-22. (canceled)

23. A system for adaptively selecting media for inclusion in a communication to be transmitted from a user communication device, said system comprising:
at least one sensor configured to capture data related to a user of a user communication device during presentation of an incoming communication on said user communication device;
at least one interface module configured to identify user characteristics based on said captured data, said user characteristics indicative of said user's reaction in response to said incoming communication; and
a context management module configured to determine an overall mood assessment of said user based on said user characteristics and to identify media associated with said mood assessment, said identified media to be included in a reply communication to be transmitted by said user communication device in response to said incoming communication.

24. The system of claim 23, wherein said at least one sensor is at least one of a camera and a microphone, said camera configured to capture one or more images of said user and said microphone to capture voice data from said user.

25. The system of claim 24, wherein said at least one interface module is a camera interface module configured to analyze said one or more images and identify physical user characteristics based on said analysis, wherein said physical user characteristics are at least one of one or more facial expressions and movement of one of more parts of said user's body resulting in one or more gestures.

26. The system of claim 25, wherein said one or more facial expressions is at least one of a smile, frown, crying, surprised, excited, confused, angry and oblivious.

27. The system of claim 24, wherein said at least one interface module is a microphone interface module configured to analyze voice data from said microphone and identify subject matter of said voice data based on said analysis.

28. The system of claim 27, wherein said voice data comprises at least one of spoken words and vocal utterances from said user.

29. The system of claim 23, wherein said context management module includes a mood determination module configured to analyze said user characteristics and determine an overall mood assessment of said user based on said analysis, wherein said mood assessment is at least one of happy, sad, excited, confused, angry, oblivious and uninterested.

30. The system of claim 23, wherein said context management module comprises a content association module configured to search for and retrieve media having content or subject matter related to said mood assessment, said media being provided by one or more media sources.

31. The system of claim 30, wherein said one or more media sources includes at least one of a local data storage included on said user communication device, an external device/system/server and a cloud-based service.

32. The system of claim 23, wherein said media includes at least one of an image, animation, audio file, video file, emoticon (static and motion), text and a network link to an image, animation, audio file or video file.

33. The system of claim 23, further comprising a media display/selection module communicatively coupled to a display to allow selection of said identified media to be transmitted by said user communication device.

34. The system of claim 23, wherein said reply communication includes at least one of a video message, virtual avatar message, voicemail message, text message and notification.

35. A method for adaptively selecting media for inclusion in a communication to be transmitted from a user communication device, said method comprising:
capturing data related to a user of a user communication device during presentation of an incoming communication on said user communication device;
identifying user characteristics based on said data, said user characteristics indicative of said user's reaction in response to said incoming communication; and
identifying media associated with at least one of said user characteristics, said identified media to be included in a reply communication to be transmitted by said user communication device in response to said incoming communication.

36. The method of claim 35, wherein said at least one sensor is at least one of a camera and a microphone, said camera configured to capture one or more images of said user and said microphone configured to capture voice data from said user.

37. The method of claim 36, further comprising analyzing said one or more images and identifying physical user characteristics based on said analysis, said physical user characteristics are at least one of one or more facial expressions and movement of one of more parts of said user's body resulting in one or more gestures.

38. The method of claim 37, wherein said one or more facial expressions is at least one of a smile, frown, crying, surprised, excited, confused, angry and oblivious.

39. The method of claim 36, further comprising analyzing said voice data and identifying subject matter of said voice data based on said analysis.

40. The method of claim 35, wherein said identifying media associated with at least one of said user characteristics comprises:
determining an overall mood assessment of said user based on said user characteristics, said mood assessment being at least one of happy, sad, excited, confused, angry, oblivious and uninterested; and
searching for and retrieving media having content or subject matter related to said mood assessment, said media being provided by one or more media sources.

41. The method of claim 35, further comprising allowing selection of said identified media and including selected identified media in said reply communication.

42. The method of claim 35, wherein said media includes at least one of an image, animation, audio file, video file, emoticon (static and motion), text and a network link to an image, animation, audio file or video file.

43. The method of claim 35, wherein said reply communication includes at least one of a video message, virtual avatar message, voicemail message, text message and notification.

44. A system including at least a device, the system being arranged to perform the method of claim 35.

45. A chipset arranged to perform the method of claim 35.

46. At least one computer accessible medium having instructions stored thereon which, when executed by a computing device, cause the computing device to carry out the method according to claim 35.

47. A device configured to adaptively select media for inclusion in a communication to be transmitted, the device being arranged to perform the method of claim 35.

48. A system configured to perform the method of claim 35.
